(19) United States
(12) Patent Application Publication
(10) Pub. No.: US 2024/0403089 A1
(43) Pub. Date: Dec. 5, 2024

(54) JUST IN TIME OPTIMIZATION OF CLOUD RESOURCES FOR SERVICE CALLS

(71) Applicant: INTERNATIONAL BUSINESS MACHINES CORPORATION, ARMONK, NY (US)

(72) Inventors: Albert Alexander Chung, Cary, NC (US); Alexander Dalton Chung, Cary, NC (US)

(21) Appl. No.: 18/326,187

(22) Filed: May 31, 2023

(51) Int. Cl. G06F 9/455; G06F 9/50

(52) U.S. Cl. CPC G06F 9/45508; G06F 9/5077

(57) ABSTRACT

A method, computer system, and a computer program product are provided for optimizing just in time routing of resources for performing a plurality of service calls in a distributed cloud-based computer system environment. Runtime data and remote data associated with resource needs associated with the plurality of service calls to be performed is obtained. A business value associated with each of the plurality of service calls is calculated. The business value has a calculated tangible and intangible element. A business flow dependency graph is generated based on the business value calculated. A service call prediction path for each of the plurality of service calls is generated based on said business flow dependency graph. Using the service call prediction path and the business value calculated, routing and provisioning of the plurality of resources for each of the plurality of service calls is provided.

### BACKGROUND

The present invention relates generally to the field of data management and more particularly to techniques for providing optimization of cloud-based service calls based on priority.

Application Resource Management (ARM) may be defined as the process of ensuring applications perform optimally, use the optimal amount of resources to manage cost while maintaining compliance. Application Performance Management (APM) relies on Software System Observability. Observability may be a measure of how well the internal states of the system can be inferred by analyzing its external outputs and can use. Data Observability provides the ability to understand the health of the data in software systems.

APM and ARM have been successfully implemented in cloud-based environments. The APM monitors applications and resources in the cloud. ARM handles the data retrieved from APM for optimization of cloud resources. APM monitors infrastructure/application metrics like latency, traffic, saturation and errors. ARM provides the intercepting and gathering of in-flight data in service calls. However, combining this information with other data to aid ARM in achieving service call prioritization has not be implemented.

### SUMMARY

Embodiments of the present invention disclose a method, computer system, and a computer program product for performing a plurality of service calls in a distributed cloud-based computer system environment. Runtime data and remote data associated with resource needs associated with the plurality of service calls to be performed is obtained. A business value associated with each of the plurality of service calls is calculated, using the runtime and remote data obtained. The business value has a calculated tangible and intangible element. A business flow dependency graph is generated based on the business value calculated. A service call prediction path for each of the plurality of service calls is generated based on said business flow dependency graph. Using the service call prediction path and the business value calculated, routing and provisioning of the plurality of resources for each of the plurality of service calls is provided.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an provides an operation flowchart for just in time prioritization in routing and provisioning of resources for a plurality of service calls in a distributed cloud-based computer system environment, according to one embodiment;

FIG. 3 provides a block diagram providing the methodology as per the embodiment of FIG. 2;

FIG. 4 illustrates an example incorporating some of the concepts of embodiments of FIGS. 2 and 3; and

FIG. 5 provides a block diagram illustrating a scenario with two downstream predicted paths, according to one embodiment.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

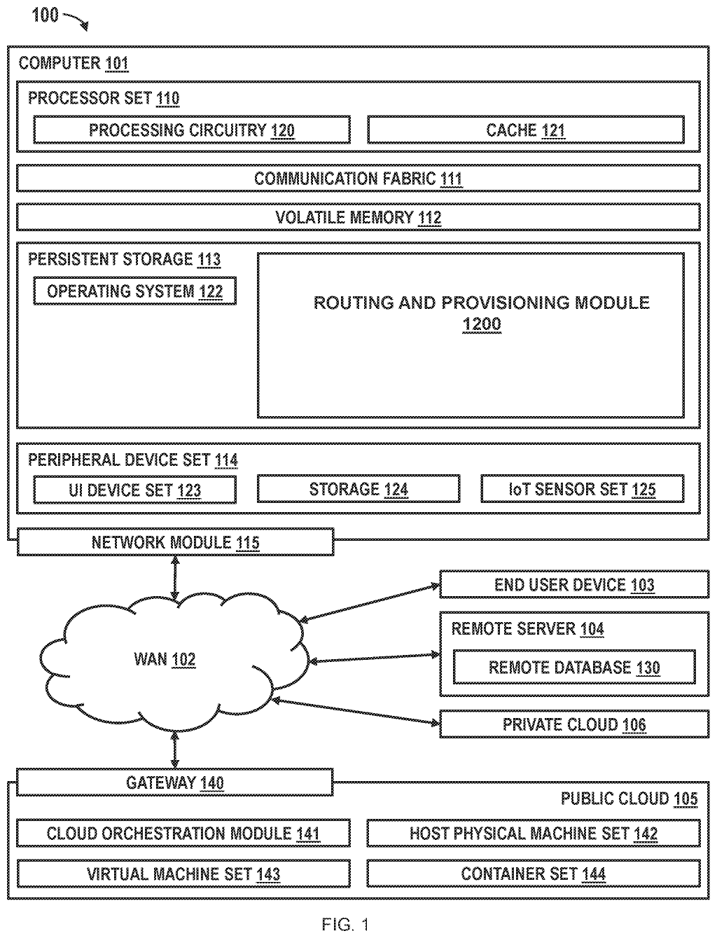

FIG. 1 provides a block diagram of a computing environment 100. The computing environment 100 contains an example of an environment for the execution of at least some of the computer code involved in performing the inventive methods, such as code change differentiator module which is capable of providing a routing and provisioning of resources thorough a routing and provisioning module (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In a distributed cloud environment, microservices may be deployed to cloud resources to service calls. These deployed microservices normally take an egalitarian approach to service calls. Every call may be treated equally in terms of computation resource allocation. However, from a business point of view, some calls may be more important than others. For example, if a service is processing the sale of paper notebook and the sale of a computer notebook. It may be more important to ensure the sale of the computer notebook transaction to succeed. This means some service calls may be treated as priority or very important priority (VIP calls), as they may impact the business bottom line. This may not be a problem when the volume of the calls are not high and enough resources are available to handle the calls. However, if computation resources are scarce or costly to provision, then it makes good business sense to prioritize high value calls (VIPs) to run on high performant cloud resources to ensure performance and success for them.

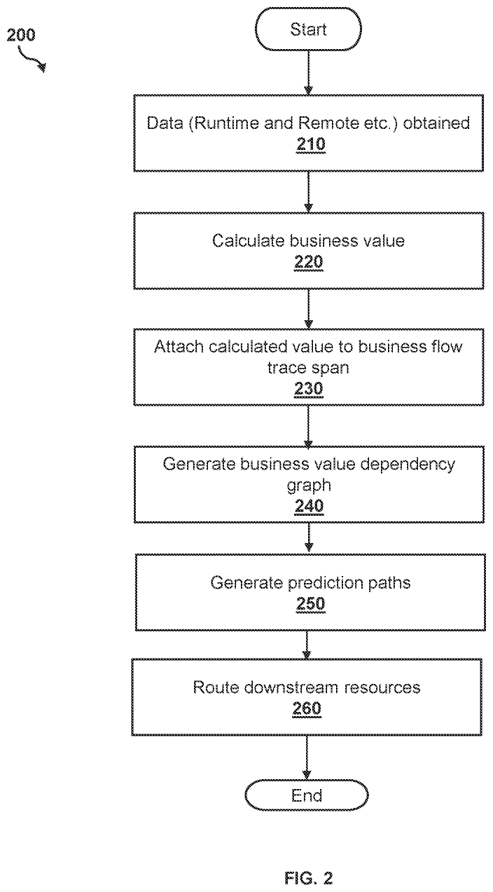

FIG. 2 provides a flowchart depiction of one embodiment to provide a just in time optimization technique for service calls especially in a cloud environment. Process 200 provides one embodiment where the value of each call may be determined, and the call's future path may be predicted. This allows for dynamic routing and/or provision of higher performance resources for one or more (1 to n) downstream microservice processing. Once the priority calls (hereinafter VIP calls) end, the higher perming resources can be de-provisioned. This just in time process of routing/provisioning cloud resources for VIP calls can ensure VIP calls succeed while still maintaining a fine grain control of the cloud resources. In one embodiment, this will be done automatically without changing any application source code (i.e., this may be done without the knowledge and participation of the application).

In one embodiment, when an application associated with one or more microservices has been deployed to a cloud environment, the application be monitored by an APM system. In this manner, application traces, cloud infrastructure metrics and application logs may be sent and correlated in the APM backend.

In one embodiment, as shown by Process 200, the business value or individual calls may be calculated automatically as they arrive at service endpoints. This may be done outside of the application code (for example, using Java agent or aspect-oriented programming (AOP)).

The business value may be correlated to the distributed trace ID or a BPM business ID via annotations in trace spans. The cloud infrastructure metrics (where the service endpoint is running on) may be correlated to the trace in the APM backend. Using the trace id correlation, a data flow graph of historical trace records can be generated that may predict the sub-calls path(s). If the flow provides a BPM process, the BPM flow diagram may be used to determine the sub-call path(s).

In one embodiment, at this point the business value of the call has been determined. Other information may also be determined such as which infrastructure the service endpoint will be running on, the current resource utilization metrics on the infrastructure and the future path of the calls and/or any sub-calls. If the infrastructure metrics for the current endpoint and the sub-call endpoints have resource or performance issues, the sub-calls may be rerouted to high performant resources. However, using high performant resources can be costly. This is where knowing the business value of the call becomes important. High business value calls can trigger routing to/provisioning higher performant resources.

In this way, process 200 provides for a just-in-time routing and provisioning of cloud based resources based on the business value of a service call. To this end, as illustrated, in Step 210, runtime data and remote data relating to any running applications and resources may be obtained for a to be performed service call. In one embodiment, an external agent may be used to dynamically retrieve both the runtime data and remote data for calculating the business value of each service call.

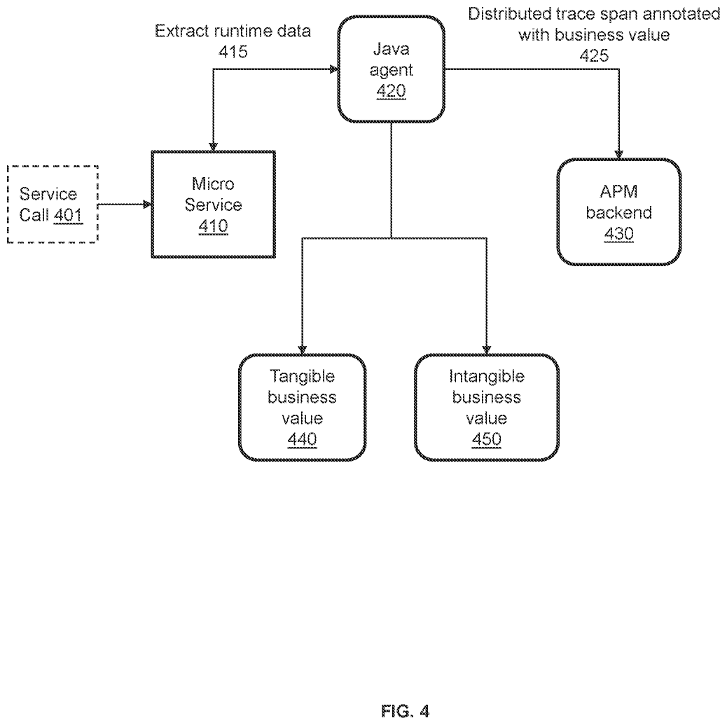

In Step 220, the business value of each call may be calculated using the retrieved dynamic and remote data. In one embodiment, the business value may be calculated based on a combination of values including the runtime data, tangible business value, intangible business value and the service component business value into a single business value for the service component. This will be discussed in more detail in FIG. 4.

This may include several steps of its own. For example, tangible and intangible business value extracted may be used to provide specifically related information related to the service component as will be discussed in more detail later. In addition, a service component specific business value extractor can be used. This may be because not all service components are created equal. Some service components may be essential for the successful completion of a business transaction, while other components can fail and do not affect the net outcome of the transaction. The business value for a specific component can be calculated by a combination of configuration (decided by the user) and dynamically checking distributed trace graph to determine if the call is critical to the success of the overall application.

In addition, in one embodiment, an overall business value combiner may also be used (not shown). This will use the overall business value from the previously mentioned components to calculate and combine the business values by using a (customer) configured weighted formula as discussed.

In Step 230, the calculated business value may be attached to a trace span and in Step 240 this may be used to generate a value dependency graph. In one embodiment, this graph may be a trace dependency graph using the business value previously calculated.

In one embodiment, once a business value for a particular call to a service component has been calculated, it may be useful to see the business values in a business flow dependency graph. Distributed tracing technology can be leveraged to create spans for each of the service components. The spans give a parent/child relationship between service components and the business values can be added to the corresponding trace spans. In one embodiment, the tracer will send spans to the APM backend for storage and processing.

In Step 250, historical data may be obtained, and the trace information may be used to generate a service call prediction path of service calls. In one embodiment, the prediction paths may be dynamically provided based on a variety of factors including source code, inflight runtime data and historical distribution of tracing dependency diagrams (graphs).

The business value at each endpoint can be further refined to consider the impact of the business values in the upstream services. For example, if the root business processing endpoint has the total invoice amount, the sub-call services may not know that value. This can be leveraged as discussed using the tracing's ability to know parent spans to recursively find the root of the transaction. In this way, the root or any business values can be retrieved along the trace path to compute the current endpoint's business value to provide a business value refinement.

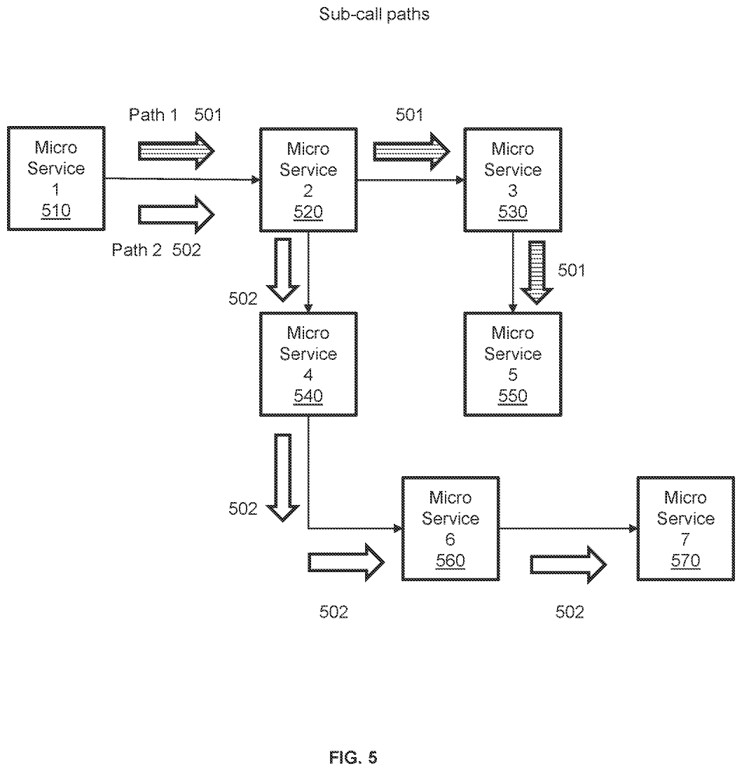

In Step 260, the business value of service calls and the prediction path may be used to route/provision any downstream could resource(s). This includes dynamically routing and provisioning of the cloud resources for each service call. This is shown in more detail later using the embodiment of FIG. 5.

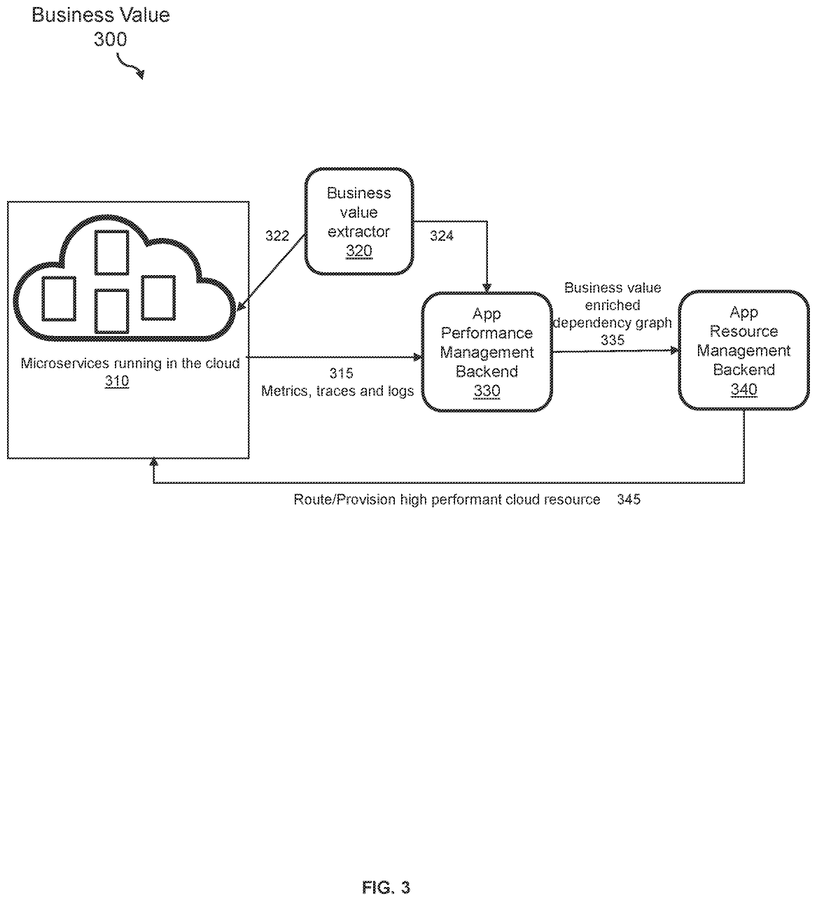

The process steps of FIG. 2 can be provided using one or more components as will be shown in more detail In FIGS. 3-5. These components are as follows:
1. Inflight data extractor—extract inflight data going to a service component that would be needed to compute the business value. For example, invoice amount, expected shipping date, priority etc.
2. Tangible business value extractor—retrieve business obligation values. For example, SLA and SLI.
3. Intangible business value extractor-retrieve potential customer impact value. For example, customer account size, customer influence, potential to future business, reputation etc.
4. Service component specific business value extractor—retrieve the importance of specific service component in relationship to the specific transaction flow.
5. Overall business value combiner—based on a weighted formula, the various business values are combined in a single business value.
6. Business value correlation to business flow dependency graph—correlate computed business value to distributed tracing span for each service that were called in the business transaction.
7. Cloud resource metadata, metrics collection—collect cloud resource metrics and metadata from cloud resources that host application service components.
8. APM backend—correlate and enrich business flow dependency graph with infrastructure resource metadata and metrics.
9. ARM backend optimizer—takes the enriched business flow dependency graph to compute the most optimal resource provisioning/scaling.

To provide an ease of understanding, the components will be discussed briefly here prior to discussing the embodiments of the figures in more detail.

Inflight data extractor—extract inflight data going to a service component that would be needed to compute the business value. For example, invoice amount, expected shipping date, priority etc.

Tangible business value extractor—retrieve business obligation values. For example, service level agreement values (SLA) and service level indicator (SLI) information.

Intangible business value extractor—retrieve potential customer impact value. For example, customer account size, customer influence, potential to future business, reputation etc.

Service component specific business value extractor—retrieve the importance of specific service component in relationship to the specific transaction flow.

Overall business value combiner—based on a weighted formula, the various business values are combined in a single business value.

Business value correlation to business flow dependency graph—correlate computed business value to distributed tracing span for each service that were called in the business transaction.

Cloud resource metadata, metrics collection—collect cloud resource metrics and metadata from cloud resources that host application service components.

APM backend—correlates and enriches business flow dependency graph with infrastructure resource metadata and metrics.

ARM backend optimizer—takes the enriched business flow dependency graph to compute the most optimal resource provisioning/scaling.

FIGS. 3-5 are now used to discuss the functionality of these components.

FIG. 3 provides a block diagram 300 illustrating some of the components of a just-in-time optimization of cloud resources. As shown in FIG. 3, a cloud having a plurality of microservices 310 is shown. In one embodiment, one or more applications may be provided running on the cloud. The applications may be implemented using a microservice architecture. The microservices may be running in containers and each microservice may have dependencies on other microservices. In one embodiment, the containers may be running in virtual machines (VMs). One or more automated operational tasks for container management can be used. One example may be uses that incorporates Kubernetes (Kubernetes is a registered trademark of Linux Foundation). Kubernetes is an open source system for automating deployment, scaling and management of containerized applications.

In one embodiment, the application(s) used and the cloud environment may be monitored by the APM backend 330. In this manner, application traces, cloud infrastructure metrics and application logs may be sent as shown at 315 and correlated in the APM backend referenced as 330. The APM backend correlates and enriches business flow dependency graph with infrastructure resource metadata and metrics.

In one embodiment, an APM system may have incorporated sensors that automatically collect cloud infrastructure resource metrics. These metrics may be auto correlated with the traces. Since the business value data to the traces may be embedded, the business values may also be corrected with the cloud infrastructure resources. From the predicted future path above, the system can ascertain the current resource utilization in the predicted path.

In one embodiment, the APM backend provides the business value in traces and the correlated infrastructure metric that can be stored in the APM backend. Business value metrics may also be provided both to the cloud (microservices through 322) and the APM (backend as referenced by 324) using the business value extractor 320 as was discussed earlier.

At this point the business value enriched dependency graph (Step 240 of FIG. 2) and provided as shown at 335 to the ARM backend referenced as 340. The ARM backend, in one embodiment, provides the business value enriched distributed trace dependency graph along with the current resource utilization in the sub-call path may be pushed to the ARM. The ARM then determines if the cloud resource in the current sub-call path is close to a certain performance threshold. If it is, then it dynamically route/provision the downstream sub-calls to higher performant resources in a just in time manner. The resources can be rerouted/deprovisioned after call completion.

The ARM backend 340 in one embodiment may be an optimizer that takes the enriched business flow dependency graph to compute the most optimal resource provisioning/scaling. As mentioned earlier, the dependency graph correlates computed business value to distributed tracing span for each service that were called in the business transaction. cs. In this way, the high-performance cloud resources can use the information to route the provisions as shown at 345.

FIG. 4 is an example incorporating concepts discussed in conjunction with FIGS. 2 and 3. In this scenario, a Java (Java is a registered trademark of Oracle Corp.) agent 420 may be used to extract runtime data 415 and provide it to the microservice(s) 410 receiving service calls 401 and distribute trace span 425 annotated with business value to the APM backend 430. A sample trace span with such extracted business value, can be as follows in one example:

```
{
  ″trace_id″: ″123″,
  ″parent_id″: ″″,
  ″span_id″: ″234″,
  ″name″: ″/foo″,
  ″start_time″: ″2021-10-22 16:04:01.209458162 +0000 UTC″,
  ″end_time″: ″2021-10-22 16:04:01.209514132 +0000 UTC″,
  ″attributes″: {
    ″invoice.total″: ″123456″,
    ″invoice.customer″: ″big inc″,
    ″SLA.performance″: ″99″,
    ″business.value″: ″1000000″
  }
}
```

The Java agent 420 also provides information necessary to extract tangible and intangible business values extractors referenced as 440 and 450 respectively, as illustrated.

The tangible business value extractor 440 can also compute business obligation values. Specifically, comparing the current tenant's SLA with the dynamically computed SLI in near real-time for the service component. It does this by:
1. Query to get the tenant ID of the running application.
2. Query to get the numeric SLA value governing the running of the application.
3. Query to the APM that is monitoring the application and the cloud infrastructure to get related performance metrics for the service component.
4. Find the difference between the expected SLA values and the actual SLI values.
5. The Business Value can be computed using a formula like this:

$$WBV = ( SLA - SLI ) \times Tw$$

Where:
WBV=Weighted Business Value
SLA=Numeric SLA value governing the running of the application
SLI=The SLI metric for the service component
Tw=The weight assigned to tangible business impact if SLA is not met

In a similar manner, the intangible business value extractor 450 computes the intangible business values specifically related to the service component. In many businesses, just knowing the value of the transaction may not enough and knowing who the customer is and the customer's influence in future sales may also important. This may be because if the customer is of high importance, more emphasis needs to be put on to ensure that the transaction completes in a performant way. Even if the current transaction dollar value may be low, other factors may make the customer and the transaction important. This can be done by intercepting the inflight data and retrieve the customer ID. If the data is not in the current call, recursively the process will go to the parent span of the trace to find the span that has the data. Using the customer ID to retrieve customer's profile and sales history, a weighted business value may then be calculated based on certain factors like past sales and potential deals.

A service component specific business value extractor (not shown) can also be used. This may be because not all service components are created equal. Some service components may be essential for the successful completion of a business transaction, while other components can fail and do not affect the net outcome of the transaction. The business value for a specific component can be calculated by a combination of configuration (decided by the user) and dynamically checking distributed trace graph to determine if the call is critical to the success of the overall application.

In one embodiment, an overall business value combiner may also be used (not shown). This will use the overall business value from the previously mentioned components to calculate and combine the business values by using a (customer) configured weighted formula as discussed.

The process as discussed may be to automatically calculate the business value of individual calls arriving at service endpoints. This may be done outside of the application code using Java agent or aspect-oriented programming (AOP). This business value is correlated to the distributed trace ID or a BPM business ID via annotations in trace spans. The cloud infrastructure metrics where the service endpoint may be running on is correlated to the trace in the APM backend. Using the trace id correlation, a data flow graph can be generated of historical trace records to predict the sub-calls path(s). If this is a business process, the business process management (BPM) can be used to determine the sub-call path(s) using a diagram such as provided in FIG. 5 as will be discussed. At this point, the business value of the call is known, which infrastructure the service endpoint is running on, the current resource utilization metrics on the infrastructure and the future path of the sub-calls. If the infrastructure metrics for the current endpoint and the sub-call endpoints have resource or performance issues, the sub-calls can be rerouted to high performant resources. However, using high performant resources can be costly. Knowing the business value of the call becomes important here as the high business value calls can trigger routing to/provisioning higher performant resources.

In one embodiment, the application service component is written in Java and can be used to dynamically capture the inflight data without changing the application source code This can be, for example achieved by an Java instrumentation API and applications such as Bytebuddy code generation and manipulation library.

For ease of understanding an example can be provided below. In this example, the application consists of 2 classes:

```
    Helloworld.java:
  package com.example;
  Public static void main (String [ ] args) {
    Greeter greeter = new Greeter (″Mr.″);
    Greeter. Greet (″foo″);
  }
}
      Greeter.java
    Package com example,
    Public class Greeter {
      String salutations;
      Public Greeter (String salutation) {
        this.salutation = salutation;
    }
    public void greet(String name) {
        System.out.printi1n (″hello world ″ + salutation + ″ ″ +
    name );
    }
}
```

The application is instrumented with these two classes—Agent.java uses Byte buddy library to intercept calls to Greeter.greet.

```
public static void premain(String arguments, Instrumentation
instrumentation) {
  new AgentBuilder.Default( )
    .type(ElementMatchers.nameContains(″Greeter″))
    .transform((builder, type, classLoader, module) -> builder
      .method(ElementMatchers.nameContains(″greet″)
      .intercept(Advice.to(GreetAdvice.class))
    ).installOn(instrumentation);
    }
  }
```

GreetAdvice.java is the interception handler. It intercepts the name parameter in greet( )

```
  package com.example.intercept;
  import net.bytebuddy.asm.Advice;
  public class GreetAdvice {
    @Advice.OnMethodEnter
    public static void getParametrs(@Advice.Argument(0) String name,
  @Advice.FieldValue(″salutation″) String salutation) throws Exception {
    System.out.println(″Intercepted parameter name is: ″ + name);
    System.out.println(″Intercepted field salutation is: ″ + salutation);
  }
}
```

Running the Helloworld program with static agent, the Dynamic agent may also be used to attach to the running Helloworld JVM
Java—java agent:agent.jar—jar helloworld.jar
Output of instrumented Helloworld program:
Intercepted parameter name is: foo
Intercepted field salutation is: Mr.
Hello world Mr. foo

The example above shows how live inflight data can be captured using Java Instrumentation API and Bytebuddy library. Similarly, for non-Java programming languages, Aspect Oriented Programming (AOP) can be used to achieve similar results.

Using the above approach, any service component can be instrumented for use and any source code can be used to intercept inflight data. The data extracted at a specific service component would be specific to that component in the business flow. The data to be extracted and the weighted formula to compute an overall business value for the component may be preconfigured in a configuration file. Using the online store checkout component for example, the invoice total, shipping priority, product ID and customer ID can be extracted. The product ID may be used to retrieve the original cost from datastore. The customer ID can be lookup customer importance based on size, past purchase history score. The Weighted Business Value formula could look something like the following example:

$$WBV = ( In - Co ) \times Pw + S \times Sw$$

Where:
WBV=Weighted Business Value
In=Invoice price
Co=Cost price
Pw=Profit weight percentage
S=Shipping priority rating
Sw=Shipping priority weighted percentage

FIG. 5 provides a block diagram showing a scenario with two downstream predicted paths. In one embodiment inflight data and historical trace data is used to predict these downstream call paths. As discussed in Step 260 of FIG. 2, as provided by the block diagram illustration of FIG. 5, a variety of microservices 1-7, each referenced by numerals 510-570 are provided. In this embodiment, using inflight data and historical trace data to predict downstream call paths that provide two distinct sub-call paths 501 and 502 (path 1 and path 2).

To predict the future path of the sub-calls, the system will get 3 pieces of information. One, the source code of the microservice. This will give a possible if/else path of the sub-calls. Two, the inflight parameter values and field values of class variables in the service. This will allow the system to know which if/else path the code will end up. Then, a historical trace dependency graph allows the system to know the sub-call paths (cloud infrastructure-where the sub-calls will go.) In case of a BPM process, this can be leveraged to determine the sub-call path as well.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for optimizing just in time routing of resources in a distributed cloud-based environment, the method comprising:
obtaining runtime data and remote data associated with resource needs of said plurality of service calls to be performed;
calculating a business value associated with each of said plurality of service calls using said runtime and remote data, wherein said business value has a calculated tangible and an intangible element;
generating a business flow dependency graph based on said calculated business value;
generating a service call prediction path for each of said plurality of service calls based on said business flow dependency graph; and
using said service call prediction path and said calculated business value, provisioning and routing a plurality of resources for each of said plurality of service calls.

2. The method of claim 1, wherein a plurality of microservices is used for routing and provisioning of said plurality of resources for each of said plurality of service calls.

3. The method of claim 1, further comprising attaching said business value to said business flow dependency graph.

4. The method of claim 3, wherein said business dependency path is a distributed trace span.

5. The method of claim 4, wherein an application resource manager is used to route and provision said plurality of resources.

6. The method of claim 5, wherein said service call has a plurality of associated resources and applications used to calculate the business value.

7. The method of claim 2, further comprising:
predicting routing of a plurality of sub calls associated with said resources, wherein said prediction is made based on a distributed tracing dependency diagram, code associated with said microservices and inflight runtime data.

8. The method of claim 7, wherein said distributed tracing dependency diagram is generated from historical trace data obtained.

9. The method of claim 1, wherein historical distributed trace dependency data is obtained to generate said service call prediction path.

10. The method of claim 1, wherein obtaining runtime data and remote data includes retrieving runtime service level agreement (SLA) values and service level indicator (SLI) data.

11. The method of claim 10, wherein said SLA and SLI data is used to determine a tangible business value component for said service call received.

12. The method of claim 11, wherein runtime data, said tangible business value and said intangible business value and a generated service component business value are combined into a single business value.

13. The method of claim 1, wherein at least one customer profile file is used to determine said intangible business value for each service call.

14. The method of claim 1, wherein the business value of a plurality of service components are also determined for each service call request.

15. A computer system for optimizing just in time routing of resources in a distributed cloud-based environment, comprising:
one or more processors, one or more computer-readable memories and one or more computer-readable storage media;
program instructions, stored on at least one of the one or more storage media for execution by at least one of the one or more processors via at least one of the one or more memories, to obtain runtime data and remote data associated with resource needs associated with said plurality of service calls to be performed;
program instructions, stored on at least one of the one or more storage media for execution by at least one of the one or more processors via at least one of the one or more memories, to calculate a business value associated with each of said plurality of service calls using said runtime and remote data, wherein said business value has a calculated tangible and an intangible element;
program instructions, stored on at least one of the one or more storage media for execution by at least one of the one or more processors via at least one of the one or more memories, to generate a business flow dependency graph based on said calculated business value;
program instructions, stored on at least one of the one or more storage media for execution by at least one of the one or more processors via at least one of the one or more memories, to generate a service call prediction path for each of said plurality of service calls based on said business flow dependency graph; and
program instructions, stored on at least one of the one or more storage media for execution by at least one of the one or more processors via at least one of the one or more memories, to use said service call prediction path and said calculated business value, provisioning and routing a plurality of resources for each of said plurality of service calls.

16. The computer system of claim 15, wherein a plurality of microservices are used for routing and provisioning of said plurality of resources for each of said plurality of service calls.

17. The computer system of claim 15, wherein said business dependency path is a distributed trace span.

18. The computer system of claim 15, wherein obtaining runtime data and remote data includes retrieving runtime service level agreement values (SLA) and scalable link interface (SLI) data.

19. The computer system of claim 15, wherein at least one customer profile file is used to determine said intangible business value for each service call.

20. A computer program product for optimizing just in time routing of resources in a distributed cloud-based environment, the computer program product comprising:
one or more computer readable storage media;
program instructions, stored on at least one of the one or more storage media for execution by at least one of the one or more processors via at least one of the one or more memories, to obtain runtime data and remote data associated with resource needs associated with said plurality of service calls to be performed;
program instructions, stored on at least one of the one or more storage media for execution by at least one of the one or more processors via at least one of the one or more memories, to calculate a business value associated with each of said plurality of service calls using said runtime and remote data, wherein said business value has a calculated tangible and an intangible element;
program instructions, stored on at least one of the one or more storage media for execution by at least one of the one or more processors via at least one of the one or more memories, to generate a business flow dependency graph based on said calculated business value;
program instructions, stored on at least one of the one or more storage media for execution by at least one of the one or more processors via at least one of the one or more memories, to generate a service call prediction path for each of said plurality of service calls based on said business flow dependency graph; and
program instructions, stored on at least one of the one or more storage media for execution by at least one of the one or more processors via at least one of the one or more memories, to use said service call prediction path and said calculated business value, provisioning and routing a plurality of resources for each of said plurality of service calls.
